(19) United States
(12) Patent Application Publication
(10) Pub. No.: US 2023/0324050 A1
(43) Pub. Date: Oct. 12, 2023

(54) CONTROL KNOB, CONTROL SYSTEM AND HOUSEHOLD APPLIANCE

(71) Applicant: BSH Hausgeräte GmbH, Munich (DE)

(72) Inventors: Roberto Carballo Fernandez, Santander (Cantabria) (ES); Alvaro Martinez Diez, Peñacastillo (Santander) (ES)

(21) Appl. No.: 18/024,519

(22) PCT Filed: Sep. 14, 2021
(86) PCT No.: PCT/EP2021/075196

§ 371 Date: Mar. 3, 2023

(30) Foreign Application Priority Data
Sep. 30, 2020 (EP) 20382864.5

(51) Int. Cl. F24C 3/12; F21V 33/00; F16K 31/60

(52) U.S. Cl. CPC F24C 3/126; F16K 31/607; F21V 33/0044

(57) ABSTRACT

A control knob for rotating a shaft in a household appliance, in particular for operating a valve shaft in a gas valve of a cooking hob. The control knob comprises:
a knob element for manual operation by an operator, the knob element comprising an opening; and
a coupling element made of light-transmitting material configured to send light through the opening towards the operator;
the coupling element being configured to connect the knob element to the shaft in a rotationally fixed manner.

The present invention relates to a control knob for rotating a shaft in a household appliance. The present invention further relates to a control system and to a household appliance with such a control knob.

Control knobs can be manually rotated by an operator such as to rotate a shaft connected to the control knob and accordingly modify an operational state of a household appliance. Such control knobs are for example used on gas cooking hobs to modify the flame size by tuning a gas valve. Illuminating the control knob can facilitate the selection of the desired setting by the operator, in particular, when the control knob is used in a badly lightened room.

WO 2018/030751 A1 discloses an example of an illuminated control knob. A knob with an integrated shaft housing is connected to a shaft. Around the shaft housing, a light guide element is provided for guiding light from below a cooktop to the control knob and outputting the light to the operator.

Further illuminated control knobs are for example shown in EP 2 701 031 A2 and US 2013/0228038 A1.

It is one object of the present invention to provide an improved control knob.

According to a first aspect, a control knob for rotating a shaft in a household appliance, in particular for operating a valve shaft in a gas valve of a cooking hob, is provided. The control knob comprises:
a knob element for manual operation by an operator, the knob element comprising an opening; and
a coupling element made of light-transmitting material configured to send light through the opening towards the operator;
the coupling element being configured to connect the knob element to the shaft in a rotationally fixed manner.

The coupling element is implemented both for coupling the control knob to the shaft and for illuminating the control knob. Providing the coupling element with these two different functionalities is advantageous in that a single element is sufficient to achieve the coupling of the control knob to the shaft and the control knob illumination. Since a single element is used, an assembling process of the control knob can be facilitated. In particular, no additional element is necessary to connect the control knob to the shaft.

It may be an advantage that between a light source, e.g. below a top plate or panel of a household appliance, and the opening in the knob element, only one piece without any further material interfaces is arranged. Thus, the light guiding efficiency is improved. Less energy is necessary to emit light from the opening towards an operator.

The control knob may be a rotatable control knob. It can be used on any type of household appliance, in particular gas cooking hobs, dishwashers, washing machines and the like. The control knob can be engaged with a shaft which rotates upon rotation of the control knob. Rotation of the shaft can modify a setting of the household appliance. For example, the shaft can be a valve shaft in a cooking hob, the valve shaft being connected to a gas valve and allowing selection of the amount of gas to be output (and hence modification of a flame size).

The knob element may be the portion of the control knob that the operator touches and rotates to modify a setting of the household appliance. The knob element can be seen as an outer housing of the control knob. Manual operation means that the operator rotates the knob element by hand.

The opening in the knob element may be a through-hole connecting an inside of the control knob to an outside of the control knob. In particular, the opening is formed on the portion of the gripping element that is operatable by the operator, for example such that the operator can see the opening. In particular, the opening is not formed on a side of the knob element which faces a plate of the household appliance onto which the control knob is arranged.

Light-transmitting (or equivalently, light-guiding) material can include transparent, partly transparent or translucent materials. Making the coupling element of light-transmitting material is advantageous because a homogeneity of light sent out through the opening can thereby be improved. The coupling element may be at least partially made of a plastic material, for example comprising polycarbonate. The coupling element is preferably made entirely of such light-transmitting material.

The coupling element can be arranged at least partly within (inside) the knob element. In order to send (output) light, the coupling element may be capable of guiding light. In particular, the coupling element guides light from an external light source, through the control knob and towards the opening. The external light source may be provided separately from the control knob. Sending light through the opening to the operator in particular means that the operator can see the light guided by the coupling element through the opening. In particular, sending light towards the operator means that the light is emitted from the inside of the control knob to the outside of the control knob through the opening. In particular, the opening connects the coupling element to the outside of the control knob, where the operator is positioned.

The coupling element connecting the knob element to the shaft in a rotationally fixed manner in particular means that the coupling element is configured to transfer a rotational force from the knob element to the shaft. In particular, the rotational force from the knob element is transmitted to the shaft only be the coupling element. For example, the knob element does not directly transfer any rotational force onto the shaft. The coupling element may physically be arranged between the shaft and the knob element. Preferably, the coupling element is in direct contact with the shaft, namely without any further element therebetween. The coupling element may be connected to the shaft in an engaging manner, in particular in a form-locking manner. “Rotationally-fixed” here means that no relative rotation between the knob element and the shaft are permitted.

According to an embodiment, the coupling element is arranged at least partially inside or, with respect to the operator, behind the opening in the knob element.

The coupling element may be positioned such that the operator only sees the portions of the coupling element that are visible through the opening. The coupling element may extend into and/or through the opening or be arranged behind the opening such that light sent by the coupling is output through the opening. Arranging the coupling element at least partly inside the opening increases the emitted light intensity and homogeneity.

According to a further embodiment, the knob element is at least partially made of a non-light-transmitting material.

Non-light-transmitting material (or equivalently non-light-guiding material) in particular designates a material that cannot guide light. Such materials for example include opaque materials such as metal or opaque plastics. Providing a knob element that is partially made of a non-light-transmitting material is advantageous because the light is then only transmitted by the coupling element. An intensity of light sent out through the opening can thereby be increased. Alternatively, the knob element can be made of a material that poorly transmits light.

According to a further embodiment, the opening is formed as a slit inside the knob element, the slit extending in a plane including the axis of rotation of the shaft or parallel thereto.

The slit may extend parallelly to the plane including the axis of rotation of the shaft. The slit may extend solely through a surface of the knob element, or extend to the inside of the knob element to form a slit-shaped accommodation portion for accommodating the coupling element at least partly.

According to a further embodiment, the opening extends through an axial face and/or circumferential surface of the knob element.

Here and in the following, the “axial” direction corresponds to the axis of rotation of the shaft. In other words, it corresponds to the rotation axis of the control knob. The terms “radial” and “circumferential” are to be understood with reference to the above-described axial direction.

The opening extending through the axial face and through the circumferential surface of the knob element is advantageous because the operator can see the light from different orientations.

According to a further embodiment, the knob element has a T-shaped cross section, in particular comprising a base portion and a gripping portion axially protruding therefrom. In other configuration, the knob element may have a cylindrical section, where the base portion and the gripping portion have essentially the same or similar diameter of circular section.

The gripping portion can form a narrowed portion of the knob element, which facilitates gripping and operating (rotating) the control knob. The base portion may be the portion of the knob element which faces the plate of the household appliance when arranged on the household appliance.

According to a further embodiment, the coupling element comprises a sleeve portion for receiving the shaft along an axial direction so as to provide the rotationally fixed connection.

The shaft can be inserted into the sleeve portion. To provide the rotationally fixed connection, the shaft can have a D-shaped cross-section (namely, it can comprise a flattened side) and an inside of the sleeve portion for accommodating the shaft can have a corresponding D-shaped cross-section. Alternative matching cross sections of the shaft and the sleeve portion are also possible.

According to a further embodiment, the coupling element further comprises:
a plate shaped portion extending inside the slit formed in the knob element and configured to send out light through at least one of its edges,
a connecting portion connecting the plate shaped portion to the sleeve portion and arranged inside a recess in the knob element so as to transfer a rotational force acting on the knob element onto the coupling element.

The plate shaped portion may have the shape of a thin plate. When inserted into the slit, opposite surfaces of the plate-shaped portion can be facing and/or in contact with surfaces of the slit of the holding portion. In particular, the plate shaped portion and the slit have at least partially identical and/or matching shapes to allow insertion of the plate shaped portion into the slit. Inserting the plate-shaped portion into the slit may further make the plate shaped portion engage with the knob element such that the coupling element and the knob element are connected to each-other in a rotatably fixed manner. The (parallel) surfaces of the plate shaped portion may have a substantially rectangular shape. The plate-shaped portion may extend in a plane comprising the axis of rotation of the shaft or parallel thereto. The plate shaped portion may extend in a plane parallel to the slit. The edges through which the plate shaped portion emits light through the opening are in particular located on a radial and/or axial end portion of the plate shaped portion. The plate shaped portion is shaped such as to optimize the concentration and diffusion of the light, thereby improving the light intensity and homogeneity at the opening.

The connecting portion may have a substantially cuboidal shape. The connecting portion may have a thickness that is larger than a thickness of the plate-shaped portion. Thereby, the connecting portion strengthens the coupling element. In particular, the connecting portion transfers at least some of the rotational force acting on the knob element onto the coupling element to reduce the rotational force acting on the thinner plate shaped portion.

The recess in the knob element preferably has a shape identical and/or corresponding to the one of the connecting portion in order to accommodate the connecting portion therein. The plate shaped portion and the connecting portion may have a T-shaped cross-section.

According to a further embodiment, the plate shaped portion extends radially further than the connecting portion.

Thereby, the plate shaped portion can be inserted all the way into the slit and the output light intensity can be increased.

According to a further embodiment, the control knob comprising a single screw fixing the connecting portion to the knob element.

In particular, the connecting portion and the knob element are attached to each-other in a rotationally fixed manner through (i) the plate shaped portion being inserted into the slit and/or (ii) the connecting element being arranged in the recess of the knob element, and (iii) a single screw connecting the connecting portion and the knob element. In particular, items (i) and/or (ii) prevent relative rotations between the knob element and the coupling element, while item (iii) fixes the knob element and the coupling element to one another axially. Instead of a screw, any other element for axially fixing the knob element and the coupling element to one another can be used, for example a clip, a pin, glue or the like. In order to attach the screw, the connecting portion can comprise a threaded through-hole located away from the rotation axis and the knob element can comprise a corresponding threaded hole. The screw is preferably fixed away from the rotation axis. Advantageously, a single screw is sufficient for fixing the connecting portion and the knob element because item (i) and/or (ii) already prevent relative rotations between the connecting portion and the knob.

According to a further embodiment, the plate shaped portion, the connecting portion and/or the sleeve portion are formed integrally.

In particular, the entire coupling element is formed integrally (as a single piece). “Integrally” means that the plate shaped portion, the connecting portion and/or the sleeve portion form one common part and are not assembled of different parts. The plate shaped portion, the connecting portion and/or the sleeve portion being integrally formed is in particular advantageous because the number of elements to be assembled to form the control knob can be reduced. Further, light refraction at the boundary between different elements can be prevented by forming the plate shaped portion, the connecting portion and/or the sleeve portion integrally. The intensity and homogeneity of light output through the opening is thereby improved

According to a further embodiment, the control knob further comprises radial ribs connecting the sleeve portion to the connecting portion and/or a spring portion inserted into the sleeve portion.

The radial ribs can strengthen a connection between the sleeve portion and the connecting portion. The spring portion can have a pipe shape or a D-shape in cross section and be insertable into the sleeve portion such as to make the sleeve portion more resistant. Alternatively, such a spring portion may also be arranged around the sleeve portion. Materials for the spring portion include stainless steel or other metal materials with resistance against corrosion.

According to a second aspect, a manual control system for a household appliance, in particular for a cooking hob, is provided. The manual control system comprises:
a control knob according to the first aspect or according to an embodiment thereof; and
a rotatable shaft, in particular a valve shaft of a gas valve, coupled to the coupling element of the control knob in a rotationally fixed manner.

The embodiments and features described with reference to the control knob according to the first aspect or according to an embodiment thereof apply mutatis mutandis to the manual control system according to the second aspect and vice versa.

According to a third aspect, a household appliance, in particular a cooking hob, comprising:
a control knob according to the first aspect or according to an embodiment thereof; and
a rotatable shaft, in particular a valve shaft of a gas valve, coupled to the coupling element of the control knob in a rotationally fixed manner.

The embodiments and features described with reference to the control knob according to the first aspect or according to an embodiment thereof apply mutatis mutandis to the household appliance according to the third aspect and vice versa.

According to an embodiment, the household appliance further comprises a light source for emitting light towards the coupling element, wherein the coupling element is configured to guide the light emitted by the light source and to send it towards the operator through the opening in the knob element.

In particular, the household appliance includes a plate with a top surface, a bottom surface and an opening for a rotatable shaft extending between the top surface and the bottom surface. The control knob is arranged on the top surface of the plate. The coupling element and/or the shaft may extend through the opening in the plate.

The light source can be a light emitting element and/or a light guiding element arranged on and/or below the bottom surface of the plate and which is configured to emit and/or guide light towards the coupling element. The light source may include one or several LEDs. The sleeve portion may be longer than the thickness of the plate, such that light from the light source can be directed efficiently towards the sleeve. Alternatively or additionally, a light guiding may be provided between the light source and the sleeve portion to guide light from the light source to the sleeve portion. The light from the light source may be input to the sleeve portion, guided through the connecting portion and towards the plate shaped portion, through the edges of which it is then emitted to the outside of the control knob towards the operator.

Further possible implementations or alternative solutions of the invention also encompass combinations—that are not explicitly mentioned herein—of features described above or below with regard to the embodiments. The person skilled in the art may also add individual or isolated aspects and features to the most basic form of the invention.

Further embodiments, features and advantages of the present invention will become apparent from the subsequent description and dependent claims, taken in conjunction with the accompanying drawings, in which:

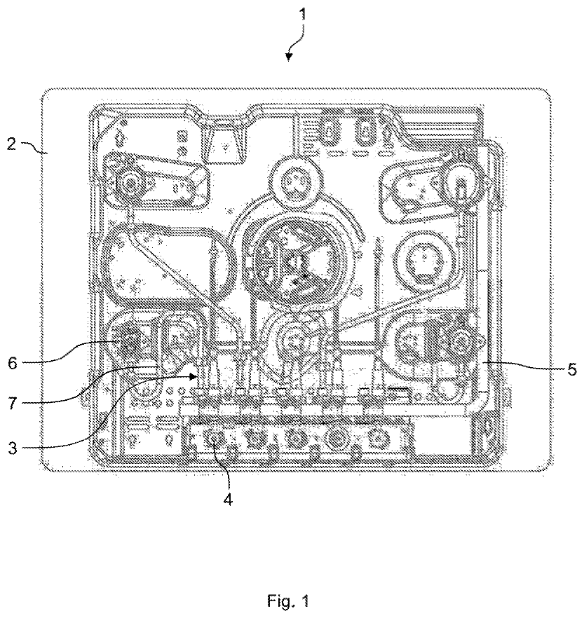

FIG. 1 shows a top view of one embodiment of a gas cooking hob;

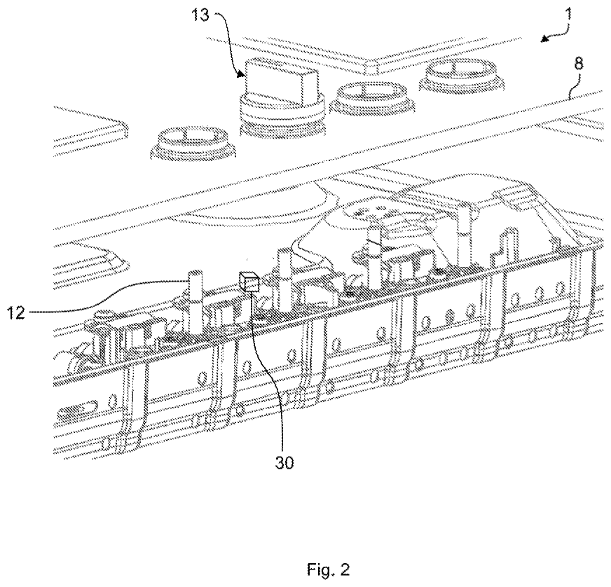

FIG. 2 shows a perspective view of the gas stove according to FIG. 1;

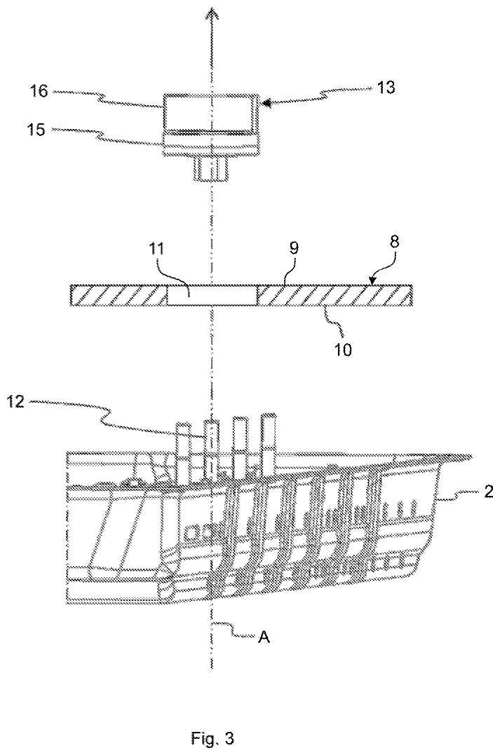

FIG. 3 shows an exploded perspective view of the gas stove according to FIG. 1;

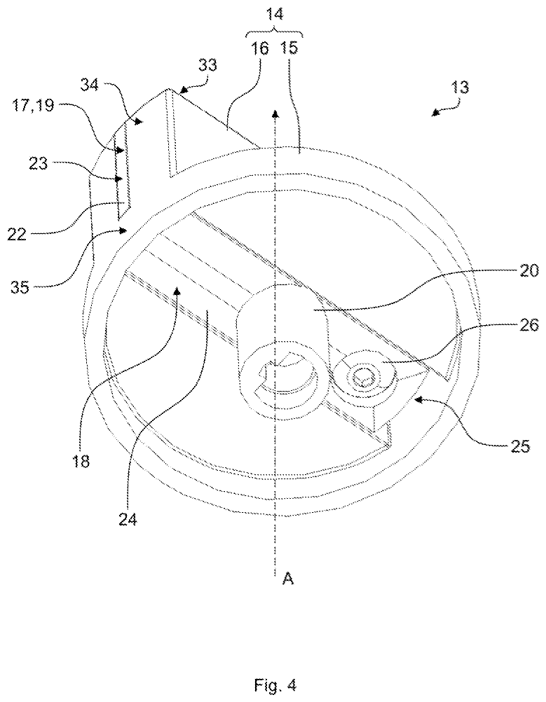

FIG. 4 shows a perspective view of one embodiment of a control knob for the gas stove according to FIG. 1;

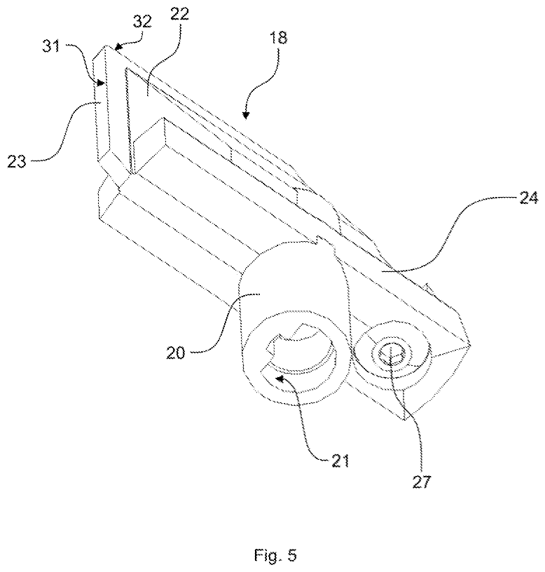

FIG. 5 shows an example of a coupling element for the control knob of FIG. 4;

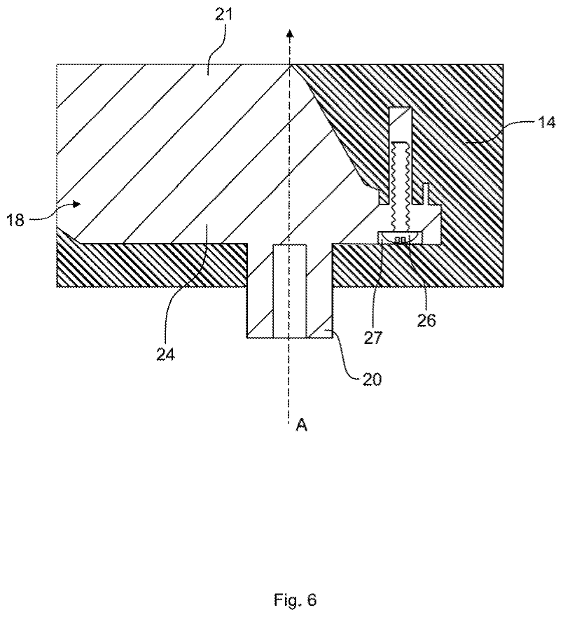

FIG. 6 shows a cross sectional view of a portion of the control knob of FIG. 4;

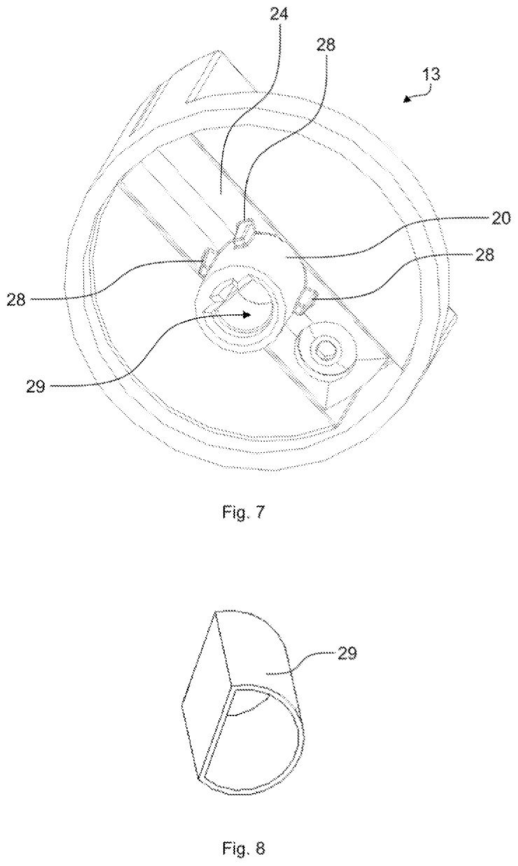

FIG. 7 shows a perspective view of another embodiment of a control knob for the gas stove according to FIG. 1; and

FIG. 8 shows an example of a spring for the control knob of FIG. 7.

In the Figures, like reference numerals designate like or functionally equivalent elements, unless otherwise indicated.

FIG. 1 shows a schematic top view of an embodiment of a gas cooking hob or gas stove 1.

FIG. 2 shows a schematic perspective view of the gas stove 1. FIG. 3 shows a schematic exploded perspective view of the gas stove 1. In the following, FIGS. 1 to 3 are referred to at the same time.

The gas stove 1 can be a household appliance or part of a household appliance. The gas stove 1 comprises a cooking trough 2. The cooking trough 2 is a deep-drawn metal sheet. The gas stove 1 further has at least one gas burner arrangement 3. The number of gas burner arrangements 3 is arbitrary. As FIG. 1 shows, there can be provided five gas burner arrangements 3.

Each gas burner arrangement 3 comprises a gas valve 4 which is attached to a main gas pipe 5, a gas burner 6 and a gas conduit 7 which connects the gas valve 4 to the associated gas burner 6. The gas valve 4 preferably is a gas regulating valve. The gas valve 4 is suitable for regulating a stream of combustion gas from the main gas pipe 5 to the gas burner 6 continuously or stepwise. In particular, the gas valve 4 is a so-called step valve. The gas valve 4 is preferably clamped to the main gas pipe 5.

A light source 30 is associated to the valve 4 for illuminating the control knob 13 from below. The control knob 13 ca be operated by the user of the gas stove.

The cooking trough 2 is covered by means of a cover plate or top sheet 8. The plate 8 covers the cooking trough 2. The plate 8 is a glass plate or a glass-ceramic plate. The plate 8 can also be made of metal, in particular stainless steel. The plate 8 has a front side (upper surface) 9 and a back side (bottom surface) 10. The front side 9 faces to a potential user of the cooking hob 1. The back side 10 is facing the cooking trough 2. The plate 8 comprises a number of breakthroughs (openings) 11. The number of breakthroughs 11 is the same as the number of gas valves 4. Each gas valve 4 has its own breakthrough 11. The breakthroughs 11 are cylindrical bores. In the following only one breakthrough 11 and only one gas valve 4 will be referred to.

The gas valve 4 is arranged below the plate 8. That means, the gas valve 4 faces the back side 10 of the plate 8. The gas valve 4 has a shaft (actuation stem) 12 which is guided through the breakthrough 11. In particular, the shaft 12 can be guided from the back side 10 to the front side 9 of the plate 8. However, the shaft 12 can end before the plate 8 so that it is not guided through the breakthrough 11. The shaft 12 can be rotated around an axis of rotation A to adjust the flow of combustion gas from the main gas pipe 5 to the gas burner 6. Depending on an angle of rotation of the shaft 12, the flow of combustion gas from the main gas pipe 5 to the gas burner 6 can be increased, decreased or completely blocked. An electronic board or circuit board (not shown) is arranged between the gas valve 4 and the plate 8. In use of the gas stove 1, the circuit board has to be protected from fluids like water or spilled food. The shaft 12 can be guided through the circuit board.

As can be seen in FIG. 4, each gas valve 4 has a control knob 13 for actuating the shaft 12. “Actuating” in this context, means rotating, in particular around the shaft rotation axis A. The control knob 13 comprises a knob element 14, which is manually operable 5 (rotatable) from the outside by an operator. The knob element 14 is preferably made of plastic. The knob element 14 can be made of acrylonitrile butadiene styrene (ABS), polypropylene (PP), polyethylene (PE) or any other suitable opaque plastic material. In embodiments, the knob element 14 is made of a metal material. The knob element 14 can be made by injection molding.

The knob element 14 has a base portion 15. The base portion 15 is cylinder shaped (circular cylinder). From an upper side of the base portion 15, a gripping portion 16 protrudes. The gripping portion 16 is bar-shaped. The gripping portion 16 can be gripped with two fingers to rotate the shaft 12. The gripping portion 16 and the base portion 15 are integrally formed.

Inside the knob element 14 a slit 19 forms an opening 17 in the knob element 14 and a recess 25 for partly accommodating a coupling element 18 of the control knob 13. The coupling element 18 is shown in a perspective view in FIG. 5. The coupling element 18 includes a sleeve portion 20 into which the shaft 12 is insertable. A sleeve interior 21 has a D-shape in cross section to engage with the shaft 12, which equally has a D-shape. Thereby, relative rotations between the shaft 12 and the coupling element 18 are prevented.

The coupling element 18 further includes a plate shaped portion 22 formed as a thin substantially rectangular plate which is insertable into the slit 19 of the knob element 14 such that edges 23 including a radial end portion 31 and an axial end portion 32 are visible to an operator through the opening 17. The shape of the slit 19 matches the shape of the plate shaped portion 22. The plate shaped portion 22 and the sleeve portion 20 are connected to one another through a connecting portion 24. The connecting portion 24 is thicker than the plate shaped portion 22. As shown in FIG. 4, the connecting portion 24 can be inserted into the recess 25 of the knob element 14. The only portion of the coupling element 18 that is not inserted inside the knob element 14 is the sleeve portion 20.

The sleeve portion 20, the connecting portion 24 and the plate shaped portion 22 of the coupling element 18 are formed integrally. They are all made of a light-guiding material comprising polycarbonate.

As shown in FIG. 2, the gas stove 1 includes a light source 30 arranged in the cooking trough 2. The light source 30 includes a plurality of LEDs which emit light towards the rotation axis A. The part of the sleeve portion 20 protruding from the connecting portion 24 being longer than the thickness of the plate 8, the sleeve portion 20 extends below the plate 8. There, it is located in the light path of the light emitted by the light source 30. The light emitted by the light source 30 is coupled into the sleeve portion 20 and guided through the sleeve portion 20, through the connecting portion 24, through the plate shaped portion 22 and finally through the opening 17 towards the operator. Since the opening 17 extends through an axial face 33 and through a circumferential surface 34 of the knob element 14, the operator can see the light output through those two sides 33, 34.

The light sent out through the opening 17 has a high intensity and homogeneity because an integrally formed coupling element 18 with an optimized shape is used. Further, the integrally formed coupling element 18 facilitates the assembly process of the control knob 13. In detail, the control knob 13 only comprises two elements to be assembled together: the coupling element 18 and the knob element 14. In the assembly process, the coupling element 18 is inserted into the knob element 14 as previously described. The plate shaped portion 22 is inserted into the slit 17 and the connecting portion 24 is inserted into the recess 25. Thereby, a relative rotation between the coupling element 18 and the knob element 14 is prevented. To axially fix the coupling element 18 to the knob element 14, a screw 26 is attached through a screw hole 27 of the coupling element 18 to the knob element. A relative axial displacement of the coupling element 18 relative to the knob element 14 is further avoided by means of a bridge portion 35, which maintains a part of the plate shaped portion 22 which axially extends further than the connecting portion 20 in place axially.

The fixing of the coupling element 18 to the knob element 14 is further shown in the sectional view of FIG. 6. FIG. 6 is a section of the control knob 13 of FIG. 4 along a plane of the plate shaped portion 22 and of the slit 19.

FIG. 7 shows a perspective view of another embodiment of a control knob 13 for the gas stove according to FIG. 1. The control knob 13 of FIG. 7 is identical with the control knob 13 of FIG. 4, except that it additionally includes ribs 18 and a spring portion 29 (further shown in FIG. 8). The ribs 18 are radial ribs arranged on an outer surface of the sleeve portion 20 and on the connecting portion 24, thereby strengthening the connection between the sleeve portion 20 and the connecting portion 24. The spring 29 is a metal spring with a D-shaped cross section which is arranged on the interior 21 of the sleeve portion 20 to strengthen the sleeve portion 20.

Although the present invention has been described in accordance with preferred embodiments, it is obvious for the person skilled in the art that modifications are possible in all embodiments. For example, the knob element 14 may have a cylindrical shape, without gripping portion 16. The opening 17 may extend only along the axial face 33 or along the circumferential surface 34, or there may be several openings in the knob element 14 for outputting light. The shape of the coupling element 18 may be adapted accordingly. Further, instead of the sleeve portion 20, the coupling element 18 may include an axis to be engaged with a sleeve-shaped shaft 12.

### REFERENCE NUMERALS

1 gas stove
2 cooking trough
3 gas burner arrangement
4 gas valve
5 main gas pipe
6 gas burner
7 gas conduit
8 plate
9 front side
10 back side
11 breakthrough
12 shaft
13 control knob
14 knob element
15 base portion
16 gripping portion
17 opening
18 coupling element
19 slit
20 sleeve portion
21 sleeve interior
22 plate shaped portion
23 edge
24 connecting portion
25 recess
26 screw
27 screw hole
28 rib
29 spring element
30 light source
31 radial end portion
32 axial end portion
33 axial face
34 circumferential surface
35 bridge portion
A rotation axis

1-15. (canceled)

16. A control knob for rotating a shaft in a household appliance, in particular for operating a valve shaft in a gas valve of a cooking hob, the control knob comprising:
a knob element for manual operation by an operator, the knob element comprising an opening; and
a coupling element made of light-transmitting material configured to send light through the opening towards the operator, the coupling element being configured to connect the knob element to the shaft in a rotationally fixed manner.

17. The control knob of claim 16, wherein the coupling element is arranged at least partially inside or, with respect to the operator, behind the opening in the knob element.

18. The control knob of claim 16, wherein the knob element is at least partially made of a non-light-transmitting material.

19. The control knob of claim 16, wherein the opening is formed as a slit inside the knob element, the slit extending in a plane including an axis of rotation of the shaft or parallel thereto.

20. The control knob of claim 16, wherein the opening extends through an axial face and/or circumferential surface of the knob element.

21. The control knob of claim 16, wherein the knob element has a T-shaped cross section.

22. The control knob of claim 16, wherein the knob element comprises a base portion and a gripping portion axially protruding from the base portion.

23. The control knob of claim 16, wherein the coupling element comprises a sleeve portion for receiving the shaft along an axial direction so as to connect the knob element to the shaft in the rotationally fixed manner.

24. The control knob of claim 23, wherein the opening is formed as a slit inside the knob element, said coupling element comprising a plate shaped portion extending inside the slit in the knob element and configured to send out light through at least one edge of the plate-shaped portion, and a connecting portion connecting the plate shaped portion to the sleeve portion and arranged inside a recess in the knob element so as to transfer a rotational force acting on the knob element onto the coupling element.

25. The control knob of claim 24, wherein the plate shaped portion extends radially further than the connecting portion.

26. The control knob of claim 24, further comprising a single screw fixing the connecting portion to the knob element.

27. The control knob of claim 24, wherein the plate shaped portion, the connecting portion and/or the sleeve portion are formed integrally.

28. The control knob of claim 23, further comprising radial ribs connecting the sleeve portion to the connecting portion and/or a spring element inserted into the sleeve portion.

29. A manual control system for a household appliance, comprising:
a control knob comprising a knob element configured for manual operation by an operator and comprising an opening, and a coupling element made of light-transmitting material configured to send light through the opening towards the operator; and
a rotatable shaft coupled to the coupling element of the control knob by connecting the knob element to the shaft in a rotationally fixed manner.

30. The manual control system of claim 29 for use in a cooking hob as the household appliance.

31. The manual control system of claim 29, wherein the shaft is a valve shaft of a gas valve.

32. A household appliance, comprising:
a control knob comprising a knob element configured for manual operation by an operator and comprising an opening, and a coupling element made of light-transmitting material configured to send light through the opening towards the operator; and
a rotatable shaft coupled to the coupling element of the control knob by connecting the knob element to the shaft in a rotationally fixed manner.

33. The household appliance of claim 32, constructed in a form of a cooking hob.

34. The household appliance of claim 32, wherein the shaft is a valve shaft of a gas valve.

35. The household appliance of claim 32, further comprising a light source for emitting light towards the coupling element, wherein the coupling element is configured to guide the light emitted by the light source and to send it towards the operator through the opening in the knob element.
